(19) United States
(12) Patent Application Publication
(10) Pub. No.: US 2019/0019592 A1
(43) Pub. Date: Jan. 17, 2019

(54) Method of Producing Energy from Condensed Hydrogen Clusters

(71) Applicant: LENR Cars SA, Ecublens (CH)

(72) Inventors: Pierre-Edouard Sottas, Préverenges (CH); Nicolas Chauvin, Ecublens (CH); Antoine Guillemin, Penthaz (CH)

(73) Assignee: LENR Cars SA

(21) Appl. No.: 16/033,415

(22) Filed: Jul. 12, 2018

Related U.S. Application Data
(60) Provisional application No. 62/531,934, filed on Jul. 13, 2017.

(51) Int. Cl. G21G 1/10; C25B 1/10; C25B 9/08

(52) U.S. Cl. CPC G21G 1/10; C25B 9/08; C25B 1/10

(57) ABSTRACT

A method of producing energy from condensed hydrogen clusters created from the desorption of hydrogen atoms from a primary material. The method of producing energy from condensed hydrogen clusters generally includes positioning at least a desorbing side of a primary material within a sealed reactor chamber. Mono-isotopic hydrogen atoms are absorbed by the primary material. Condensed hydrogen clusters are formed from the desorption of the hydrogen atoms from the primary material. Stability of the condensed hydrogen clusters is maintained by prevention of covalent bond formation and recombination into hydrogen molecules. A nuclear reaction and spallation of the stable condensed hydrogen clusters is initiated to produce reaction products. Energy may be harvested from the reaction products, such as through a coolant.

### CROSS REFERENCE TO RELATED APPLICATIONS

I hereby claim benefit under Title 35, United States Code, Section 119(e) of U.S. provisional patent application Ser. No. 62/531,934 filed Jul. 13, 2017. The 62/531,934 application is currently pending. The 62/531,934 application is hereby incorporated by reference into this application.

### STATEMENT REGARDING FEDERALLY SPONSORED RESEARCH OR DEVELOPMENT

Not applicable to this application.

### BACKGROUND

### Field

Example embodiments in general relate to a method of producing energy from condensed hydrogen clusters created from the desorption of hydrogen atoms from a primary material.

### Related Art

Any discussion of the related art throughout the specification should in no way be considered as an admission that such related art is widely known or forms part of common general knowledge in the field.

Nuclear energy production has been a rapidly-developing field for nearly a century. While the fission and fusion nuclear energy productions suffer from their respective drawbacks, an alternative way of producing nuclear energy, utilizing hydrogen reactions, has been identified. See, e.g., Mosier-Boss et al, Condensed matter nuclear reaction products observed in Pd/D co-deposition experiments, Current Science, 108(4), 656-659, 2015. The steps and methods to achieve such energy production utilizing hydrogen reactions strongly vary between inventors and authors and all suffer from a lack of reproducibility. See, for example, European Patent No. 2702593 to Piantelli, U.S. Pat. No. 8,603,405 to Miley, European Patent No. 1656678 to Dardik, U.S. Pat. No. 7,893,414 to Larsen.

Recent advances in the understanding of Rydberg matter of hydrogen and its ultra-dense form, as well as its deuterium counterpart, provide a first theoretical and experimental basis for the explanation of excess heat events that have been described in nickel-hydride experiments. See, e.g., Badiei S, Holmlid L., Atomic hydrogen in condensed form produced by a catalytic process: a future energy-rich fuel? Energy Fuels 2005; 19:2235-9.; Badiei et al, Fusion reactions in high-density hydrogen: A fast route to small-scale fusion, Int. J. Hydrogen Energy 34 (2009) 487; Focardi et al, Large excess heat production in Ni—H systems, II Nuovo Cimento A, Volume 111, Issue 11, p. 1233, 1998.

In parallel, the possibility to produce monatomic hydrogen in an excited state from metal hydrides has been demonstrated, although it is believed that Rydberg states can hardly be formed from metallic surfaces. See, e.g., Shmal'ko et al, The formation of excited H species using metal hydrides, Journal of Alloys and Compounds, 231:856-859, 1995; Aman et al, Field ionization of Rydberg alkali states outside iron oxide catalyst surfaces: peaked angular distributions of ions, Applied Surface Science 64, 71-80, 1993; Andersson et al, Angular-resolved desorption of potassium ions from basal graphite surfaces, J. Chem. Soc., Faraday Trans., 1996, 92, 4581-4588. Metals are highly abundant—titanium (TI) is the ninth most abundant element in the earth's crust—and can be easily extracted. The creation and excitation of condensed hydrogen clusters from metal hydrides would greatly facilitate the production of such nuclear energy at low temperature.

Despite that condensed hydrogen clusters can be created at a metal-metal oxide interface, no methodology has been put in place so far to initiate and control the energy released by such condensed hydrogen clusters. See, e.g., Lipson et al, Transport and magnetic anomalies below 70 K in a hydrogen-cycled Pd foil with a thermally grown oxide, Phys Rev B, 2005, 72:212507. In particular, gas-loading systems have been proposed to generate condensed hydrogen clusters, but many issues remain to develop a viable power unit. See, e.g., (Miley et al, Progress in Development of an LENR Power Cell for Space, Proceedings of Nuclear & Emerging Technologies for Space (NETS) 2015, paper 5134.

### SUMMARY

An example embodiment is directed to a method of producing energy from condensed hydrogen clusters. The method of producing energy from condensed hydrogen clusters includes positioning a primary material within a sealed reactor chamber. Mono-isotopic hydrogen atoms are absorbed by the primary material. Condensed hydrogen clusters are formed from the desorption of excited hydrogen atoms from the primary material. The formation of the condensed hydrogen clusters is facilitated by prevention of covalent bond formation and recombination in hydrogen molecules. A nuclear reaction and spallation of the stable condensed hydrogen clusters is initiated to produce reaction products. Energy is harvested from the reaction products, such as through a coolant.

There has thus been outlined, rather broadly, some of the embodiments of the method of producing energy from condensed hydrogen clusters in order that the detailed description thereof may be better understood, and in order that the present contribution to the art may be better appreciated. There are additional embodiments of the method of producing energy from condensed hydrogen clusters that will be described hereinafter and that will form the subject matter of the claims appended hereto. In this respect, before explaining at least one embodiment of the method of producing energy from condensed hydrogen clusters in detail, it is to be understood that the method of producing energy from condensed hydrogen clusters is not limited in its application to the details of construction or to the arrangements of the components set forth in the following description or illustrated in the drawings. The method of producing energy from condensed hydrogen clusters is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a sectional view of a first embodiment of a device for performing a method of producing energy from condensed hydrogen clusters in accordance with an example embodiment.

FIG. 2 is a sectional view taken along line 2-2 of FIG. 1.

FIG. 3 is a sectional view of a second embodiment of a device for performing a method of producing energy from condensed hydrogen clusters in accordance with an example embodiment.

FIG. 4 is a sectional view of a third embodiment of a device for performing a method of producing energy from condensed hydrogen clusters in accordance with an example embodiment.

FIG. 5 is a sectional view of a fourth embodiment of a device for performing a method of producing energy from condensed hydrogen clusters in accordance with an example embodiment.

FIG. 6 is a sectional view of a fifth embodiment of a device for performing a method of producing energy from condensed hydrogen clusters in accordance with an example embodiment.

FIG. 7 is a sectional view of a sixth embodiment of a device for performing a method of producing energy from condensed hydrogen clusters in accordance with an example embodiment.

FIG. 8 is a flowchart illustrating formation of stable condensed hydrogen clusters of a method of producing energy from condensed hydrogen clusters in accordance with an example embodiment.

FIG. 9 is a flowchart illustrating energy harvesting from reaction products of a method of producing energy from condensed hydrogen clusters in accordance with an example embodiment.

FIG. 10 is a flowchart illustrating a method of producing energy from condensed hydrogen clusters in accordance with an example embodiment.

FIG. 11 is a flowchart illustrating pressure-loading of a method of producing energy from condensed hydrogen clusters in accordance with an example embodiment.

FIG. 12 is a flowchart illustrating temperature being raised of a method of producing energy from condensed hydrogen clusters in accordance with an example embodiment.

FIG. 13 is a flowchart illustrating an electrolytic current being utilized in a method of producing energy from condensed hydrogen clusters in accordance with an example embodiment.

### DETAILED DESCRIPTION

An example method of generating nuclear energy from condensed hydrogen clusters formed from the controlled desorption of hydrogen atoms from a refined material generally comprises absorbing mono-isotopic hydrogen atoms in a refined hydrogen-isotopic dependent primary material which may be located inside or outside of a sealed chamber. Condensed hydrogen clusters are allowed to form from the desorption of the mono-isotopic hydrogen atoms from the primary material in excited states of hydrogen at the surface of a secondary material within a sealed chamber. These condensed hydrogen clusters may remain stable over a predetermined period of time through the prevention of the formation of covalent bonds and recombination in hydrogen molecules. The nuclear reaction and spallation of the stable condensed clusters may be initiated with the energy carried by the reaction and spallation products being harvested through a tertiary material.

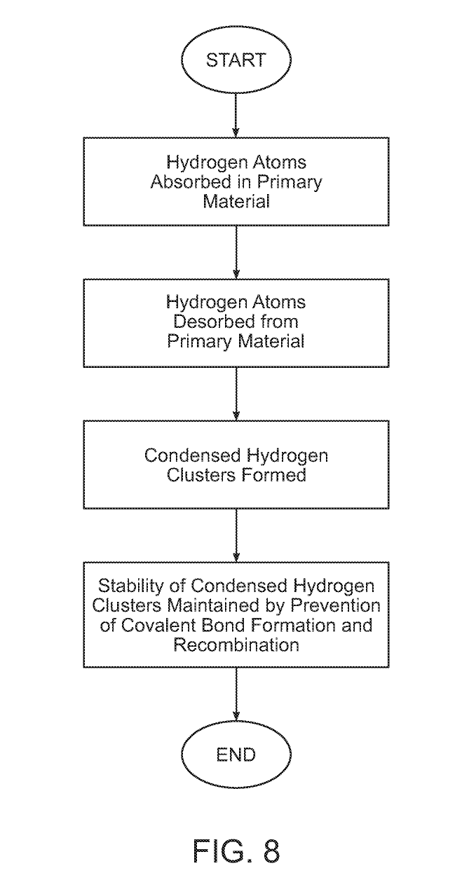

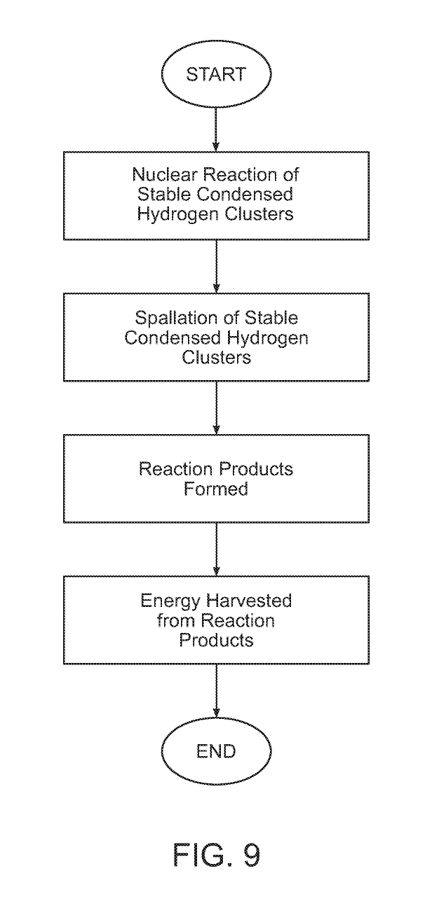

In an exemplary embodiment, the method may comprise the steps of absorbing a plurality of hydrogen atoms in a primary material 14, forming a plurality of condensed hydrogen clusters by desorbing the plurality of hydrogen atoms from the primary material 14 into excited states, initiating a nuclear reaction and spallation of the condensed hydrogen clusters to form reaction products, and harvesting energy carried by the reaction products of the nuclear reaction and spallation of the hydrogen clusters such as shown in FIG. 9. Covalent bond formation and recombination in hydrogen molecules may be prevented to facilitate the formation of the condensed hydrogen clusters and maintain their stability such as shown in FIG. 8.

The primary material 14 may be positioned within a sealed reactor chamber 10. A hydrogen gas may be introduced into the sealed reactor chamber 10 to provide the hydrogen atoms. Temperature and pressure may be controlled within the sealed reactor chamber 10. The hydrogen atoms may comprise a hydrogen isotope having a purity higher than 99%, such as deuterium. The primary material 14 may be comprised of an alloy or compound of one or more transition metals; the primary material being adapted to load the hydrogen atoms to form a hydride. The one or more transition metals may comprise silver, gold, hafnium, lanthanum, magnesium, neodymium, nickel, palladium, platinum, rhodium, tantalum, titanium, yttrium, zinc, and/or zirconium.

The step of desorbing the hydrogen atoms may be endothermic; with the hydrogen atoms comprised of deuterium. The primary material 14 may be refined to present micro- or nano-structures so as to maximize the absorption of the hydrogen atoms in the primary material 14. The primary material 14 may comprise a foil, wire, or powder.

In an exemplary embodiment, the primary material 14 may act as a hydrogen membrane including a desorbing side located in the sealed reactor chamber and an absorbing side. Using water electrolytic techniques, the hydrogen atoms may be absorbed at the absorbing side of the hydrogen membrane and desorbed at the desorbing side of the hydrogen membrane. Alternatively, hydrogen pressure charging may be utilized wherein the absorbing side of the hydrogen membrane is exposed to a higher pressure than the desorbing side of the hydrogen membrane.

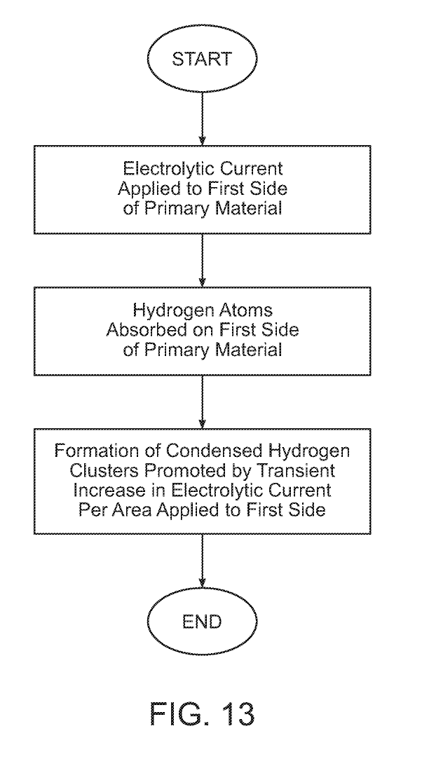

The hydrogen atoms may be absorbed on a first side of the primary material and desorbed on a second side of the primary material 14. An electrolytic current may be applied to the first side of the primary material 14 for absorption of the atoms. Desorption may be accomplished by increasing the electrolytic current from an initial value to a final value over a period of time such as shown in FIG. 13. The final current value may be at least ten times the initial current value, and the period of time may be less than one second.

A pressure may be applied to the first side of the primary material 14; with the pressure being increased from an initial value to a final value over a period of time. The final value may be at least ten times the initial value of the pressure, and the period of time may be less than one second. A temperature applied to the second side of the primary material may be increased from an initial value to a final value. The increase of temperature between the initial value and the final value may be at least 100 Kelvin.

The sealed reactor chamber 10 may comprise a high electron density, such as by including atoms having a low electronegativity. The atoms may comprise caesium, potassium, lithium, sodium, and/or rubidium. A secondary material 15 may optionally be added into the sealed reactor chamber 10 to facilitate condensation of the excited states. The secondary material 15 may comprise ruthenium, rhodium, iridium, and/or nickel. The heat from the reaction products may be transferred to a coolant 32 for energy harvesting. The coolant 32 may comprise water.

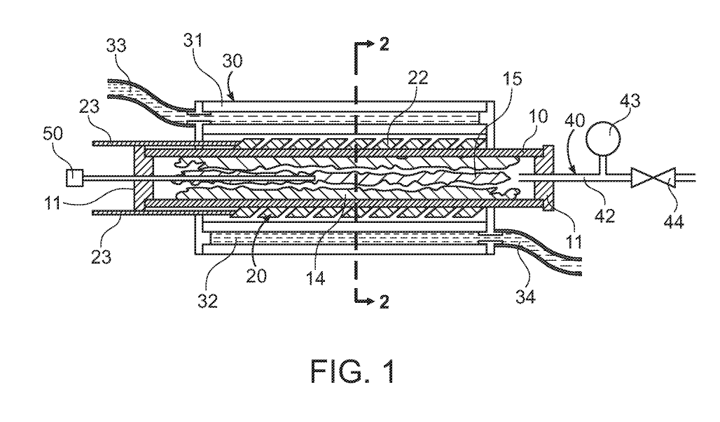

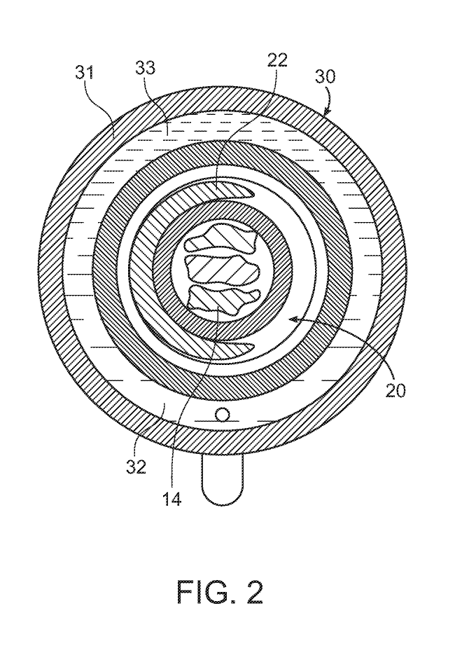

FIGS. 1 and 2 illustrate a first exemplary embodiment of a device adapted to perform the various methods described herein. As shown in FIG. 1, a primary material 14 may be positioned within a sealed reactor chamber 10. FIG. 1 also illustrates usage of a secondary material 15 within the sealed reactor chamber 10 as discussed below. It should be appreciated that the secondary material 15 may be omitted in some embodiments; with only the primary material 14 being utilized. Chamber seals 11 may be positioned at either end of the reactor chamber 10 to create a sealed environment for the primary material 14.

In the embodiment shown in FIGS. 1 and 2, a heating element 20 may be utilized to raise the temperature of the primary material 14. By way of example and without limitation, the heating element 20 may comprise a Joule heating element 22 such as shown in FIGS. 1 and 2 in which heat is produced by the passage of an electrical current through a conductor. A heating element input 23 is shown which may connect the Joule heating element 22 with a current source (not shown). In the embodiment shown in FIGS. 1 and 2, the Joule heating element 22 is positioned to surround the reactor chamber 10.

As shown in FIGS. 1 and 2, a cooling element 30 may be utilized to allow finer control of the temperature of the primary material 14 during usage. The cooling element 30 may comprise a cooling jacket 31 through which a coolant 32 may flow. The cooling element 30 may include a fluid inlet 33 and a fluid outlet 34 through which the coolant 32 may enter and exit the cooling jacket 31 respectively. The coolant 32 may be utilized to harvest thermal energy created by the methods described herein such as by any number of methods known in the art for extracting energy from a heating coolant 32. Various coolants 32 may be utilized, including any fluid known to transfer heat, such as but not limited to water.

In the embodiment of FIGS. 1 and 2, pressure may be controlled by a pressure monitor 40. The pressure monitor 40 may comprise a pressure sensor 43, a gas inlet 42, and a valve 44 from which hydrogen gas may be modulated. The pressure monitor 40 may monitor the pressure within the reactor chamber 10 as the internal pressure will affect optimal temperatures. The pressure monitor 40 may also be adapted to raise or lower the pressure as-needed to stay within optimal thresholds. A temperature sensor 50 is also shown which will monitor the temperature so that appropriate adjustments may be made to the heating element 20 to maintain temperature within optimal thresholds.

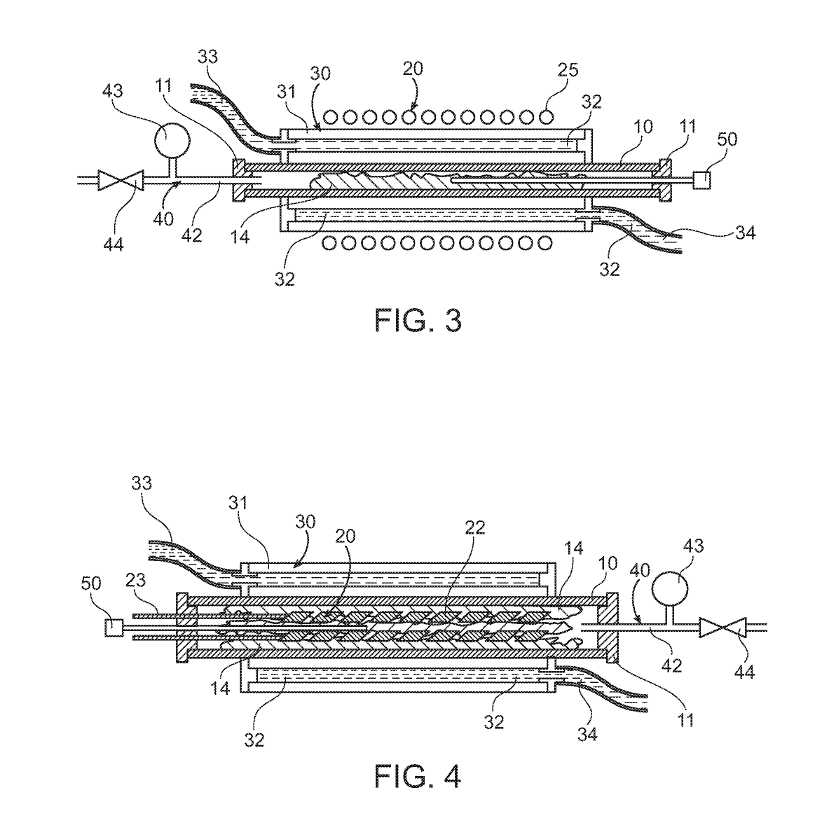

FIG. 3 is another exemplary embodiment of a device adapted to provide energy utilizing the methods described herein. As shown in FIG. 3, a primary material 14 is sealed within a reactor chamber 10 having a pair of seals 11 at its distal ends. The primary material 14 may be heating by a heating element 20; with the embodiment of FIG. 3 illustrating usage of an inductive heating element 25 by which heat is generated by eddy currents. A temperature sensor 50 may be provided to monitor temperatures and adjust the heating element 20 as needed.

As shown in FIG. 3, a cooling element 30 may be utilized for temperature control and to harvest energy. The cooling element 30 may comprise a cooling jacket 31 through which a coolant 32 may flow via a fluid inlet 33 and a fluid outlet 34. Pressure within the reactor chamber 10 may be controlled by a pressure monitor 40 comprising a pressure sensor 43, gas inlet 42, and a valve 44 from which hydrogen gas may be modulated.

FIG. 4 is another exemplary embodiment of a device adapted to provide energy utilizing the methods described herein. In the embodiment shown in FIG. 4, a primary material 14 is positioned internal to a sealed reactor chamber 10. Heating is provided in the embodiment of FIG. 4 by a Joule heating element 22, though other types of heating elements 20 could be utilized. The Joule heating element 22 of FIG. 4 is illustrated as being internal to the reactor chamber 10. Temperature may be controlled by a temperature sensor 50 extending into the reactor chamber 10 to monitor the thermal characteristics of the primary material 14.

As shown in FIG. 4, a cooling element 30 may at least partially extend around the reactor chamber 10. The cooling element 30 is illustrated in this embodiment as comprising a cooling jacket 31 and a coolant 32 flows via a fluid inlet 33 and a fluid outlet 34 through the cooling jacket 31.

Continuing to reference FIG. 4, a pressure monitor 40 may be utilized to detect and control the pressure within the reactor chamber 10. The pressure monitor 40 may comprise a gas inlet 42 through which gas such as hydrogen may be introduced into the reactor chamber 10 and a valve 44 for modulating the gas entering the reactor chamber 10. A pressure sensor 43 may continuously detect the pressure within the reactor chamber 10.

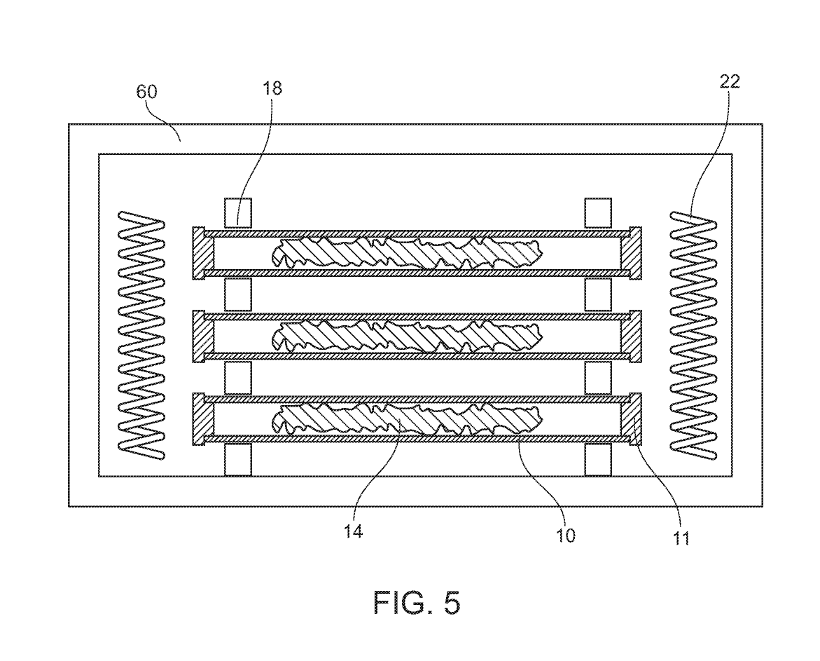

FIG. 5 is another exemplary embodiment of a device adapted to provide energy utilizing the methods described herein. FIG. 5 illustrates an embodiment in which primary material 14 is sealed within multiple reactor chambers 10, such as with seals 11 as shown. In this embodiment, heating elements 20 comprised of Joule heating elements 22 are external to the reactor chambers 10 within the enclosure 60. Reactor supports 18 may be utilized to support the reactor chambers 10 within the enclosure 60 at optimal positioning with respect to the Joule heating elements 22.

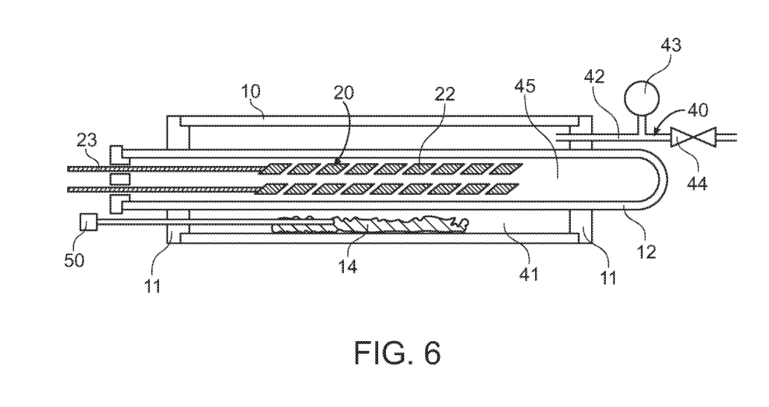

FIG. 6 is another exemplary embodiment of a device adapted to provide energy utilizing the methods described herein. In the embodiment shown in FIG. 6, an outer reactor chamber 10 is positioned to surround an inner reactor chamber 12; with the inner reactor chamber 12 being embedded within the outer reactor chamber 10. In the embodiment shown, the outer and/or inner reactor chambers 10, 12 may be tubes with seals 11. The tubes may comprise various materials, including glass, quartz, alumina, and ceramic tubes. In this embodiment, the atmosphere 41 within the outer reactor chamber 10 will be different from the atmosphere 45 within the inner reactor chamber 12.

As shown in FIG. 6, a heating element 20 such as a Joule heating element 22 controlled by a heating power input 23 and a temperature sensor 50 will be positioned within the atmosphere 41 of the outer reactor chamber 10. The primary material 14 will be positioned within the outer reactor chamber 10 in a different atmosphere 41 than that of the inner reactor chamber 12. The pressure of the atmosphere 41 within the outer reactor chamber 10 may be controlled by a gas inlet 42 adapted to introduce a gas such as hydrogen within the outer reactor chamber 10, a pressure sensor 43 for detecting the pressure of the atmosphere 41 within the outer reactor chamber 10, and a valve 44 for modulating the amount of gas introduced into the atmosphere 41 within the outer reactor chamber 10.

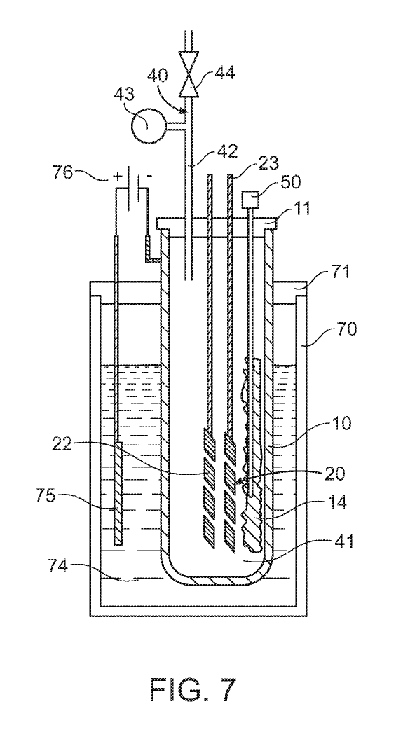

FIG. 7 illustrates yet another exemplary embodiment of a device for providing energy utilizing the methods described herein. In the embodiment of FIG. 7, an electrolytic cell 70 is utilized, with the primary material 14 acting as a membrane. The primary material 14 may be positioned within the reactor chamber 10; with the reactor chamber 10 being immersed in an electrolytic solution 74 within an electrolytic cell 70. The electrolytic cell 70 is preferably sealed by an electrolytic cell cover 71.

Continuing to reference the exemplary embodiment FIG. 7, a current generated by a power source 76 may flow between an anode 75 and the primary material 14 for hydrogen charging. Temperature of the primary material 14 may be controlled by a heating element 20 such as a Joule heating element 22, a heating power input 23, and a temperature sensor 50. The pressure of the atmosphere 41 within the reactor chamber 10 may be monitored and controlled by a gas inlet 42, a pressure sensor 43, and a valve 44.

It should be appreciated that a wide range of types of primary materials 14 may be utilized to perform the various methods described herein. The primary material 14 may comprise an alloy or compound of one or more transition metals capable of loading hydrogen atoms and forming a hydride. The alloy or compound of one or more transition metals may present no miscibility gap in the alpha- to beta-phase transition of the hydride, such as Ni1-xCux with x>0.6 and Pd1-xAgx with x>0.25 at room temperature. By way of example and without limitations, transition metals such as silver (Ag), gold (Au), iridium (Ir), hafnium (Hf), lanthanum (La), magnesium (Mg), neodymium (Nd), nickel (Ni), palladium (Pd), platinum (Pt), rhodium (Rh), tantalum (Ta), titanium (Ti), yttrium (Y), zinc (Zn) and/or zirconium (Zr) may be utilized to form the alloy or compound.

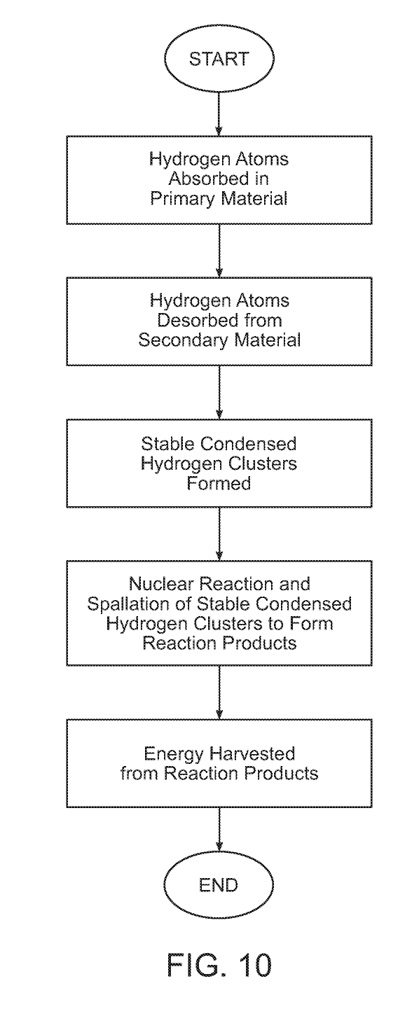

In one exemplary embodiment such as shown in FIG. 10, a method comprising the following steps may be utilized to provide energy:

i) absorbing mono-isotopic hydrogen atoms in a refined hydrogen-isotopic dependent primary material 14 located inside or outside a reactor chamber 10;

ii) allowing the formation of condensed hydrogen clusters from the desorption of the mono-isotopic hydrogen atoms from the primary material 14 at the surface of a secondary material 15 within the sealed reactor chamber 10, through the promotion of excited states of hydrogen and the prevention of the formation of a covalent bond and the recombination in hydrogen molecules, these clusters remaining stable over a predetermined period of time;

iii) initiating the nuclear reaction and spallation of the stable condensed clusters, and

iv) harvesting the energy carried by the products of the nuclear reaction and spallation of the stable condensed clusters, such as through a coolant.

In one exemplary embodiment, the absorption and desorption of hydrogen atoms are performed at the surface of the primary material 14. Repeated cycles of steps i through iii may be performed to harvest more energy at step iv. In such an embodiment, the primary material 14 will preferably have been refined to present a high surface area by a person of ordinary skills in the art so as to facilitate the absorption and desorption of the hydrogen atoms, including but not limited to the formation of micro- or nano-crystalline structures and the use of catalysts such as thiourea and arsenic for electrolytic charging. The primary material 14 may comprise a foil, wire or powder presenting micro- or nano-structures. The foil, wire or powder may be exposed to hydrogen gas in the sealed reactor chamber 10 or, alternatively, in an electrolytic charging chamber and then moved into the sealed reactor chamber 10.

In one embodiment, the primary material 14 may act as a membrane; with the absorption of hydrogen atoms performed on one side of the primary material 14 or membrane and the desorption of hydrogen atoms performed in the other side of the primary material 14 or membrane; with the hydrogen atoms diffusing in the bulk layers of the primary material 14 or membrane.

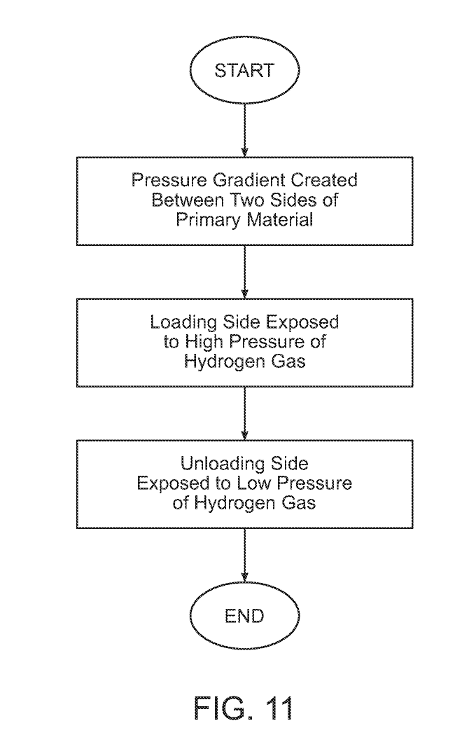

Methods such as water electrolytic techniques and high pressure hydrogen loading may be utilized by a person of ordinary skills in the art to foster the absorption of hydrogen atoms in the primary material 14. In the case of electrolytic charging, the primary material 14 or membrane may separate the electrolyte solution 74 from a gas with an electric current passed between an anode 75 and the cathodic primary material 14 or membrane. In the case of high pressure hydrogen loading, a pressure gradient may be created between the two sides of the primary material 14 or membrane; with the loading side exposed to a high pressure of hydrogen gas and the unloading side to a low pressure to facilitate the formation of condensed hydrogen clusters such as shown in FIG. 11.

In one exemplary embodiment, the absorption of atomic hydrogen by the primary material 14 may be facilitated by methods applied by a person of ordinary skill in the art, including, but not limited to, the refinement of the primary material 14 for those metals for which oxidation prevents a good absorption, the addition of a material with superior dissociative properties of molecular hydrogen (for metals for which a gas-phase hydrogen molecule incident on surface has to overcome a barrier to dissociatively absorb, e.g. 25 kcal/mol for Ni), collision-induced absorption, the use of proton acceptors, the removal of surface-bound hydrogen through collision-induced recombinative desorption with an incident beam of an inert gas at a preferred angle and a particular geometry (e.g. convex regions of the primary material for enhanced absorption and concave regions for enhanced desorption).

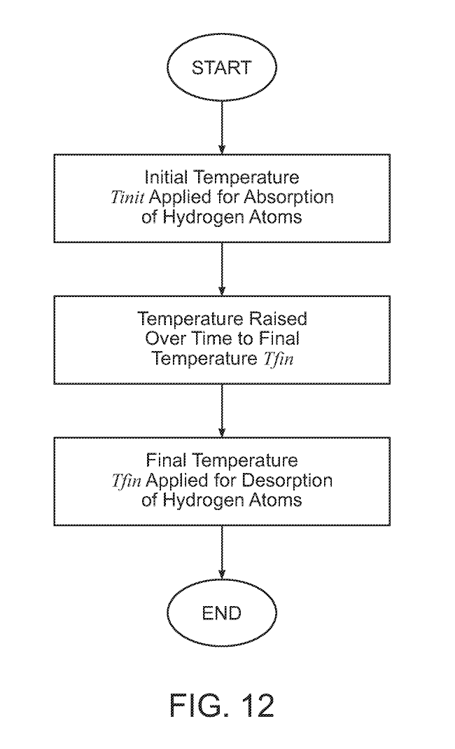

In yet another exemplary embodiment, the thermal desorption into excited states of hydrogen may be promoted through an increase from an initial temperature Tinit to a final temperature Tfin during a time t such as shown in FIG. 12. A heating element 20, such as one or more induction heating elements 25 or one or more Joule heating elements 22 internal or external to the sealed reactor chamber 10, may be controlled by a temperature sensor is used to increase the temperature Tinit to Tfin in time t. The difference between Tfin and Tinit may vary in different embodiments, including in excess of 300K, such that the absorption of hydrogen atoms is favored at temperature levels close to temperature Tinit and the desorption of hydrogen atoms is favored at temperature levels close to temperature Tfin for a given pressure of hydrogen Ph. The rate of temperature increase between Tfin and Tinit, denoted (Tfin-Tinit)/t may vary in different embodiments, including exceeding 50K per second, so as to create a stress on the absorbed hydrogen leading to a higher energy level per hydrogen atom desorbed from the bulk and in turn an enhanced desorption of the atoms with the formation of excited hydrogen species. This promoted desorption may be utilized to efficiently increase the rate of formation of excited hydrogen species.

In order to create Rydberg matter of hydrogen, it is preferable that it is bulk—and not surface—hydrogen atoms that desorb. Bulk hydrogen atoms traditionally have a significantly higher energy (about 25 kcal/mol when the primary material is Ni) as compared to that of a surface-bound hydrogen atom. See, e.g., S. T. Ceyer, The unique chemistry of hydrogen beneath the surface: catalytic hydrogenation of hydrocarbons, Accounts of Chemical Research, 34(9):737-744, 2001. Generally, only the hydrogen species freshly emerging from the bulk of the primary material 14 will efficiently form Rydberg matter then condensed hydrogen clusters.

In an exemplary embodiment, when the absorption of atomic hydrogen is performed on one side of a primary material 14 or membrane through electrolytic charging with the desorption in the other side of a primary material 14 or membrane, the formation of condensed hydrogen clusters may be promoted by a transient increase in the electrolytic current per area of the one side of the primary material 14 or membrane. For example, when the primary material 14 is Ni, the current per area is preferably transiently increased to a value higher than 0.1 A/cm2, or in some cases higher than 1 A/cm2. In one exemplary embodiment, when the absorption of atomic hydrogen is performed on one side of a primary material 14 or membrane through high pressure charging in the gas phase with the desorption in the other side of the primary material 14 or membrane, the desorption into condensed hydrogen clusters may be promoted by a transient increase in the hydrogen pressure at the one side of the primary material 14 or membrane. For example, when the primary material 14 is Ni, the hydrogen pressure at the one side of the foil may be increased to a value higher than 10 MPa, or in some embodiments, higher than 100 MPa.

The hydrogen utilized may be mono-isotopic, either >99.9% H-hydrogen or >99.8% D-deuterium. The choice of the mono-isotopic hydrogen depends on the primary material 14, more precisely on the energy level at which H-hydrogen atoms or D-deuterium atoms desorb from the bulk of the primary material 14. In particular, when desorption of hydrogen of the primary material 14 is endothermic; the isotope will preferably comprise D-deuterium. When desorption of hydrogen of the primary material 14 is exothermic, the isotope will preferably comprise H-hydrogen. The higher the energy level, the lower the requirement to have a high rate of temperature increase to favor the formation of condensed hydrogen clusters over the formation of a covalent bond and the recombination in hydrogen molecules.

Hydrogen atoms desorbing from the bulk of the primary material 14 are transiently energetic. If no method is applied to favor the formation of condensed hydrogen clusters, the desorbing hydrogen atoms will dissipate their energy and ultimately form molecular hydrogen and/or become surface-bound hydrogen. In one embodiment, the formation of condensed hydrogen clusters is made possible due to the presence of an environment having a high electron density. In one embodiment, a high electron density is obtained due to the presence of atoms having a low electronegativity. In a preferred embodiment, the atoms with a low electronegativity are selected from the alkali metal atoms caesium (Cs), potassium (K), litium (Li), sodium (Na) and rubidium (Rb).

In one exemplary embodiment, the alkali atoms may be in a phase known to present enhanced catalytic properties. In a preferred embodiment, the alkali atoms are in the gas phase. In a preferred embodiment, the temperature Tinit and temperature Tfin are chosen in a way to maintain the partial vapor pressure Pa of the alkali metal in the sealed chamber higher than 10 microbars, preferably higher than 300 microbars, preferably higher than 10 millibars.

In one embodiment, ahead of the formation of condensed hydrogen clusters, the total gas pressure Pt in the sealed chamber is preferably maintained below 1 bar in order to prevent collisions between the Rydberg matter of hydrogen and gas molecules that would destroy the loosely bound Rydberg matter structure. The determination of Tinit, Tfin, t, Pa, and Pt depends on the choice of the primary material 14 and of the alkali metal. This determination is key to prevent the formation of molecular hydrogen upon desorption and to favor the formation of condensed hydrogen clusters. When the alloy or compound of one or more transition metals is known to present at a given temperature a miscibility gap in the transition from one phase to another phase of the hydride, with the miscibility gap disappearing at a critical temperature Tc, Tinit is preferably chosen as equal or greater than Tc. Also, Tinit is preferably chosen based on the boiling point and partial pressure of the alkali metal, with Cs and Rb as preferable choices because presenting a higher Pa for given temperature Tinit and Tfin while presenting a low electronegativity.

In another exemplary embodiment, excited hydrogen atoms may be preserved thanks to their spillover on the surface of a secondary material 15. Hydrogen spillover techniques are applied on the secondary material 15 to prevent the recombination of the desorbing hydrogen atoms into molecular and to favor the formation of Rydberg matter and in turn condensed hydrogen clusters. In one embodiment, the secondary material 15 is a transition metal, preferably ruthenium (Ru), rhodium (Rh), iridium (Ir) or nickel (Ni) because of their enhanced catalytic activity, or the same primary material 14 when the primary material 14 is a transition metal. The secondary material 15 may be processed to improve its catalytic properties to dissociate molecular hydrogen. When the secondary material 15 is the same as the primary material 14, condensed hydrogen clusters can not only form near the outer surface but also in micro-cavities, voids, cracks or more generally any interstitial sites present in the bulk. The secondary material 15 may be present as a form of metal compounds, deposition, sputtering, layering, and the like with the primary material 14 in some embodiments.

As soon as the condensed hydrogen clusters start to form at the surface of the secondary material 15, the total gas pressure Pt decreases, with a rate of decrease that can be very fast given the long range interactions of Rydberg matter and in turn condensed hydrogen clusters. This moment indicates the onset of the reaction. The condensed hydrogen clusters are metastable and need to be preserved to make the reaction sustainable. In one embodiment, hydrogen gas is directly and continuously added in the sealed reactor chamber 10 through a gas inlet 42 to produce more of the condensed hydrogen clusters. The rate at which the hydrogen gas is added in the sealed reactor chamber 10, together with the temperature of the added hydrogen gas, is controlled in order to sustain the reaction. This rate depends on the amount of material present in the sealed chamber that present dissociative properties of molecular hydrogen, would it be the primary material 14, the secondary material 15 or any other material added for that purpose. The rate may be continuously adjusted to stabilize and optimize the formation of condensed hydrogen clusters based on the temperature and pressure within the reactor chamber 10.

If the reaction stops, it is required to repeat steps i and ii to re-create enough stable condensed hydrogen clusters. After the reaction is initiated, the total gas pressure Pt can be progressively increased from a low initial pressure to more than 1 bar. The formation of condensed hydrogen clusters is evidenced by the addition in the sealed chamber of an amount of hydrogen gas that exceeds by several orders of magnitude the sum of the amount of hydrogen that can be loaded in the primary and secondary materials 14, 15 plus the amount of hydrogen occupying the volume of the chamber at pressure Pt without any leak of hydrogen outside the chamber.

As shown in the work of Leif Holmlid, the condensed hydrogen clusters are mainly formed of pairs of H when the mono-isotope H-hydrogen is used, and pairs of D when the mono-isotope D-deuterium is used. See, e.g., Holmlid, Laser-mass spectrometry study of ultra-dense protium p(−1) with variable time-of-flight energy and flight length, International Journal of Mass Spectrometry 351 (2013) 61-68); Badiei et al, Laser-induced variable pulse-power TOF-MS and neutral time-of-flight studies of ultradense deuterium, Phys. Scr. 81 2010.

Condensed hydrogen clusters are generally characterized by having zero orbital angular momentum. These pairs of H or D are states of even orbital parity. In comparison, in hot nuclear fusion, e.g. D-D fusion in a hot plasma state, both D atoms have considerable angular momentum. Conservation of angular momentum imposes strong constraints on the possible types of nuclear decay and of their corresponding rates. In hot fusion, in order to dispose of the excess energy while conserving angular momentum, the intermediary excited He4 does rapidly decompose in He3 (0.82 MeV)+n (2.45 MeV) or T (1.01 MeV)+p (3.02 MeV) via the strong interaction. These two branches occur with nearly equal probability. The situation with condensed hydrogen clusters is different because both D do not carry significant angular momentum. The decay channel He4+23.9 MeV, negligible in hot plasma fusion, becomes therefore possible and the two main nuclear reactions involving the fast strong nuclear force are not dominant for condensed hydrogen clusters. However, without any electromagnetic excitation, the rate of the He4 branch remains limited because electric dipole radiation requires a parity change; something forbidden for He4 that carries the same parity as the two deuterons.

Rather, condensed hydrogen clusters are characterized by distances short enough to allow quantum tunneling and times long enough to involve the weak interaction. Pairs of D can therefore decay via the weak interaction into mesons having relativistic energies. Similarly, pairs of H can form a diproton that can decay via the weak interactions into mesons having relativistic energies. This nuclear spallation does not conserve the baryon number. The spallation of a diproton with the production of mesons having relativistic energies is facilitated by the application of a low-energy laser. See, e.g., Holmlid, Mesons from Laser-Induced Processes in Ultra-Dense Hydrogen H(0), PLoS ONE 12(1): e0169895, 2017. In the case of pairs of D, nuclear fusion in He4 as well as their spallation into mesons has been observed experimentally by Holmlid. See, e.g., Olofson & Holmlid, Time-of-flight of He ions from laser-induced processes in ultra-dense deuterium D(0), Int J Mass Spec, 2014, 374:33:38; Holmlid, MeV particles in a decay chain process from laser-induced processes in ultra-dense deuterium D(0), Int. J. Modern Phys. E 201; 24:1550026.

The nuclear fusion and spallation of condensed hydrogen clusters can be initiated through waiting, i.e. a spontaneous reaction, or triggered through an electromagnetic excitation. In one embodiment, the condensed hydrogen clusters are excited with infrared radiations. In a preferred embodiment, a diode or infrared lamp emitting in the 15-300 Thz frequency band may be used to target the secondary material 15.

In an exemplary embodiment, a tertiary material may used to facilitate the conversion of the kinetic energy of the products of the nuclear fusion and spallation in thermal energy. This tertiary material aims to cool (damp) the K mesons and their decay products comprising pions and muons. In preferred embodiment, the tertiary material has high density such as but not limited to concrete, lead, iron ore, silver. The tertiary material may be incorporated into an enclosure 60 such as shown in FIG. 5.

In one embodiment, a cooling element 30 comprising a coolant 32 may be used to harvest the thermal energy. This cooling element can either be at the surface of the sealed reactor chamber 10 or embedded within the tertiary material. When at the surface of the reactor chamber 10, the flow of the coolant 32 can be advantageously used to finer control the temperature of the primary material 14 and in turn to better stabilize the continuous formation and nuclear reaction of condensed hydrogen clusters.

The spallation of condensed hydrogen clusters may lead to the production of charged mesons and intense radio frequency radiation in the vicinity of the sealed chamber. K mesons can decay in pions and muons and produce radio frequency radiation further away from the sealed chamber. In one embodiment, an element is used to convert the electromagnetic energy associated to the radiations into direct current electricity. In a preferred embodiment, this element consists of an array of dipole antenna having each a radio frequency diode connected across the dipole elements.

In some embodiments, a compound comprising zero, one or more atoms of hydrogen and one or more alkali atoms may be incorporated into the reactor chamber 10. The compound may comprise caesium, CsH, CsD, KBH4, KBD4, LiBH4, LiBD4, LiAIH4, and/or LiAID4. The compound may preferable comprise CsH when the isotope is H-Hydrogen and CsD when the isotope is D-Deuterium. The pressure and temperature within the reactor chamber 10 may be chosen to maintain the alkali atoms in a gas phase. The partial pressure of the alkali metal in the reactor chamber 10 may comprise various values, including higher than 10 microbars, higher than 300 microbars, and higher than 10 millibars.

Unless otherwise defined, all technical and scientific terms used herein have the same meaning as commonly understood by one of ordinary skill in the art to which this invention belongs. Although methods and materials similar to or equivalent to those described herein can be used in the practice or testing of the method of producing energy from condensed hydrogen clusters, suitable methods and materials are described above. All publications, patent applications, patents, and other references mentioned herein are incorporated by reference in their entirety to the extent allowed by applicable law and regulations. The method of producing energy from condensed hydrogen clusters may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A method of producing energy from condensed hydrogen clusters, comprising:
absorbing a plurality of hydrogen atoms in a primary material;
forming a plurality of condensed hydrogen clusters by desorbing the plurality of hydrogen atoms from the primary material into excited states;
initiating a nuclear reaction and spallation of the condensed hydrogen clusters to form reaction products; and
harvesting energy carried by the reaction products of the nuclear reaction and spallation of the hydrogen clusters.

2. The method of claim 1, wherein the primary material is positioned within a sealed reactor chamber.

3. The method of claim 2, wherein hydrogen is introduced into the sealed reactor chamber.

4. The method of claim 3, comprising the step of controlling a temperature within the sealed reactor chamber.

5. The method of claim 4, comprising the step of controlling a pressure level within the sealed reactor chamber.

6. The method of claim 1, wherein the hydrogen atoms comprise a hydrogen isotope with a purity higher than 99%.

7. The method of claim 6, wherein the hydrogen isotope is comprised of deuterium.

8. The method of claim 1, wherein the primary material is comprised of an alloy or compound of one or more transition metals, the primary material being adapted to load the hydrogen atoms to form a hydride.

9. The method of claim 8, wherein the one or more transition metals are selected from a group consisting of gold, hafnium, iridium, lanthanum, magnesium, neodymium, nickel, palladium, platinum, rhodium, silver, tantalum, titanium, yttrium, zinc, and zirconium.

10. The method of claim 8, wherein the alloy or compound of one or more transition metals does not present a miscibility gap in the alpha- to beta-phase transition of the hydride.

11. The method of claim 1, wherein the primary material has been refined to present micro- or nano-structures so as to maximize absorption of the hydrogen atoms in the primary material.

12. The method of claim 12, wherein the primary material is comprised of a foil, wire, or powder.

13. The method of claim 1, wherein the hydrogen atoms are absorbed on a first side of the primary material and desorbed on a second side of the primary material.

14. The method of claim 13, comprising the step of applying an electrolytic current to the first side of the primary material.

15. The method of claim 14, wherein the step of desorbing the plurality of hydrogen atoms comprises increasing the electrolytic current from an initial value to a final value over a period of time.

16. The method of claim 15, wherein the final value is at least ten times the initial value and wherein the period of time comprises less than one second.

17. The method of claim 13, wherein a pressure applied to the first side of the primary material is increased from an initial value to a final value over a period of time.

18. The method of claim 17, wherein the final value is at least ten times the initial value and wherein the period of time is less than one second.

19. The method of claim 13, wherein a temperature applied to the second side of the primary material is increased from an initial value to a final value over a period of time.

20. The method of claim 19, wherein the increase of temperature from an initial value to a final value is of at least 100 Kelvin and wherein the period of time comprises less than 5 seconds.

21. The method of claim 1, wherein the sealed reactor chamber comprises a high electron density.

22. The method of claim 21, wherein the sealed reactor chamber comprises atoms having a low electronegativity.

23. The method of claim 22, wherein the atoms are selected from a group consisting of caesium, potassium, lithium, sodium, and rubidium.

24. The method of claim 1, comprising the step of adding a secondary material into the sealed reactor chamber to facilitate condensation of the excited states.

25. The method of claim 24, wherein the secondary material is selected from a group consisting of ruthenium, rhodium, iridium, and nickel.

26. The method of claim 1, comprising the step of transferring heat from the reaction products to a coolant.

27. The method of claim 26, wherein the coolant is comprised of water.

28. The method of claim 1, comprising the step of preventing covalent bond formation and recombination to maintain stability of the hydrogen clusters.

29. The method of claim 1, wherein the primary material acts as a hydrogen membrane, wherein a desorbing side of the hydrogen membrane is located in the sealed reactor chamber.

30. The method of claim 29, comprising the step of absorbing hydrogen atoms through water electrolytic techniques at an absorbing side of the hydrogen membrane and desorbing hydrogen atoms at the desorbing side of the hydrogen membrane.

31. The method of claim 29, comprising the step of absorbing hydrogen atoms through hydrogen pressure charging, wherein an absorbing side of the hydrogen membrane is exposed to a higher pressure than the desorbing side of the hydrogen membrane.

32. The method of claim 1, wherein the primary material is chosen according to the energy level at which the hydrogen atoms desorb from a bulk of the primary material.
